(19) United States
(12) Patent Application Publication
(10) Pub. No.: US 2015/0308589 A1
(43) Pub. Date: Oct. 29, 2015

(54) FLEXIBLE CONDUIT FOR USE IN A FIRE SUPPRESSION SYSTEM

(71) Applicant: UTC FIRE & SECURITY AMERICAS CORPORATION, INC., Bradenton, FL (US)

(72) Inventors: Michael Kenneth KRAGER, Linwood, MA (US); Bryan Robert SIEWERT, Clinton, CT (US); Michael R. CAREY, East Hampton, CT (US); Enrico MANES, Feeding Hills, MA (US); Richard J. PAHOLSKY, Rocky Hill, CT (US); Patrick PACKARD, Avon, CT (US)

(73) Assignee: UTC FIRE & SECURITY AMERICAS CORPORATION, INC., Bradenton, FL (US)

(21) Appl. No.: 14/650,957

(22) PCT Filed: Oct. 15, 2013
(86) PCT No.: PCT/US2013/064922

§ 371 Date: Jun. 10, 2015

Related U.S. Application Data
(60) Provisional application No. 61/739,318, filed on Dec. 19, 2012.

(51) Int. Cl. F16L 11/02; A62C 35/68

(52) U.S. Cl. CPC F16L 11/02; A62C 35/68

(57) ABSTRACT

An exemplary flexible conduit (26) for use in a fire suppression system (20) includes a core layer (30) that establishes interior surface (32) of the flexible conduit that is configured to contact fire suppression fluid. A jacket layer (36) surrounds the core layer. The jacket layer establishes an exterior surface (38) of the flexible conduit. A reinforcing layer (34) is situated between the interior surface and the exterior surface.

### BACKGROUND

Fire suppression systems often include sprinklers strategically located within areas of a building where protection against fire is desired. Most sprinkler systems include rigid metal pipes connecting the sprinklers to a source of water. The rigid pipes are typically heavy, cumbersome, expensive and can be difficult to install. In view of these drawbacks associated with rigid metal pipe, alternatives have been considered.

One alternative is to use chlorinated polyvinyl chloride (CPVC) pipes in place of the rigid metal pipes. CPVC pipe, however, has limitations. It is not capable of withstanding ultraviolet light exposure and is incompatible with a significant number of residential building materials. At least those two factors introduce the possibility for leaks within the system if CPVC pipe is used. Of course, any leaks require repair and further expenses.

Another proposal would be to use a flexible connector hose within a fire suppression system. U.S. Pat. Nos. 6,158,519 and 6,691,790 disclose a flexible hose within a fire suppression system. The challenges associated with using a flexible hose within a fire suppression system is achieving a hose having characteristics that allow it to withstand the pressures that are required to achieve proper sprinkler operation. The material has to have a long enough life expectancy and has to be chemically compatible with other building materials that may come in contact with the hose. The two patents mentioned above do not provide any indication of any particular material or construction of the hose to satisfy those requirements.

### SUMMARY

An exemplary flexible conduit for use in a fire suppression system includes a core layer that establishes an interior surface of the flexible conduit that is configured to contact fire suppression fluid. A jacket layer surrounds the core layer.

The jacket layer establishes an exterior surface of the flexible conduit. A reinforcing layer is situated between the interior surface and the exterior surface.

An exemplary fire suppression system includes at least one sprinkler. A flexible conduit is between the sprinkler and a source of fire suppression fluid for carrying the fire suppression fluid to the sprinkler. The flexible conduit includes a core layer that establishes an interior surface of the flexible conduit that is configured to contact the fire suppression fluid. A jacket layer surrounds the core layer. The jacket layer establishes an exterior surface of the flexible conduit. A reinforcing layer is situated between the interior surface and the exterior surface of the flexible conduit.

An exemplary method of installing a fire suppression system includes providing at least one sprinkler. A flexible conduit is manipulated into a position wherein the flexible conduit can carry fire suppression fluid to the sprinkler. The flexible conduit includes at least one bend or curve along a path between the sprinkler and a source of the fire suppression fluid. The flexible conduit has a core layer that establishes an interior surface of the flexible conduit that is configured to contact the fire suppression fluid. A jacket layer surrounds the core layer and establishes an exterior surface of the flexible conduit. A reinforcing layer is situated between the interior surface and the exterior surface.

The various features and advantages of disclosed example embodiments will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example fire suppression system including a flexible conduit designed according to an embodiment of this invention.

FIG. 2 schematically illustrates an example embodiment of a flexible hose.

### DETAILED DESCRIPTION

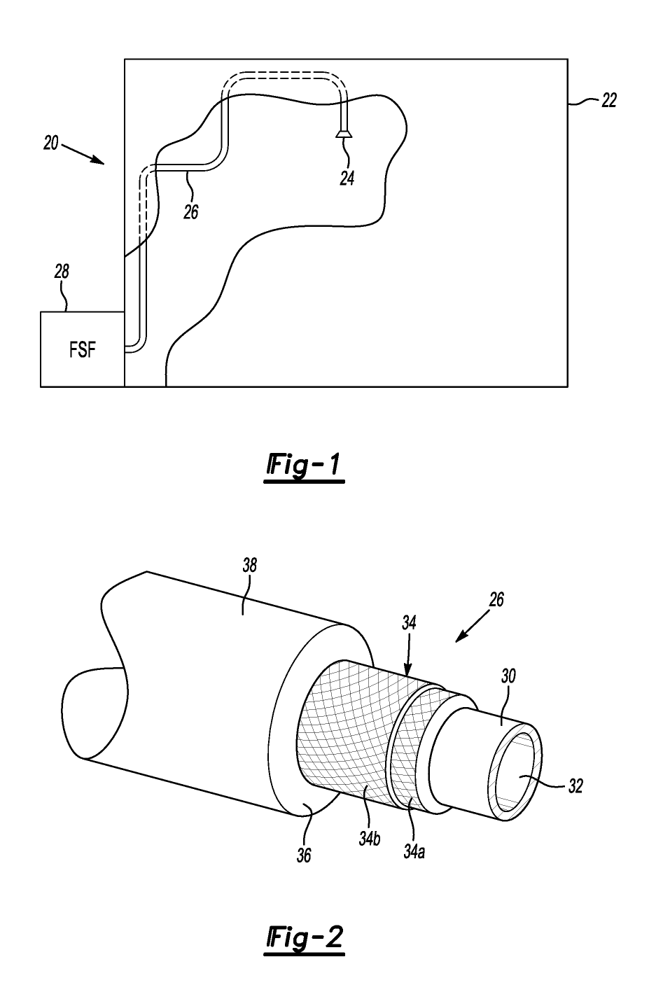

FIG. 1 schematically illustrates selected portions of a fire suppression system 20 within a building 22. At least one sprinkler 24 is situated in a position to provide fire suppression or protection for a selected area within the building 22. A flexible conduit 26 couples the sprinkler 24 to a source 28 of fire suppression fluid (FSF). For purposes of discussion, the flexible conduit 26 is described as coupling the sprinkler 24 to the source 28. The flexible conduit 26 does not need to make physical contact with the sprinkler 24 or the source 28 for this purpose. The flexible conduit 26 establishes a pathway between the source 28 and the sprinkler 24 for carrying fire suppression fluid to the sprinkler 24.

The flexible conduit 26 facilitates installation of the fire suppression system by simplifying the installation process. The flexible conduit 26 allows for including bends or curves in the flexible conduit 26 along the path that the flexible conduit 26 establishes for directing fire suppression fluid from the source 28 to the sprinkler 24. The ability to manipulate the flexible conduit 26 facilitates easily navigating around the structure of the building 22 during an installation process. The flexible nature of the conduit 26 also allows for eliminating multiple fittings and connections along the pathway between the source 28 and the sprinkler 24. For example, elbow joints would be required with rigid pipe and such joints are eliminated when the example conduit is used.

The flexible conduit 26 is designed to withstand high pressures that can be experienced within a fire suppression system. One example is capable of withstanding up to 11,000 psi, which is a pressure required for proper sprinkler nozzle activation. The flexible conduit 26 is also capable of consistently maintaining pressure on the order of 1000 psi over the expected life of the fire suppression system 20. Actual pressures may be in the 300-400 psi range while the system is idle and ready for activation, if needed.

The flexible conduit 26 has a unique construction and material composition that allows it to contain and carry the fire suppression fluid, renders it resistant to abrasion during handling or installation procedures, makes it compatible with various building materials with which it may come into contact within the building 22 and renders it flexible enough to facilitate a quicker and easier installation process.

FIG. 2 schematically illustrates an example construction of one embodiment of the flexible conduit 26. A core layer 30 establishes an interior surface 32 of the flexible conduit 26. The fire suppression fluid is carried within the core layer 30 and comes into contact with the interior surface 32. The core layer 30 comprises a first flexible material that is compatible with the fire suppression fluid so that it does not corrode and does not contaminate the fire suppression fluid over time. This feature establishes a sufficiently long useful life for the flexible conduit 26 and avoids possible interference with operation of the sprinkler 24, which otherwise might occur if the inner layer were to break down from exposure to the fire suppression fluid.

In one example, the core layer 30 comprises polyethylene. One particular example comprises the material sold under the trade name DX 900 PE-RT. Another example core material comprises nylon.

A reinforcing layer 34 is illustrated generally surrounding the core layer 30. For illustration and discussion purposes, the reinforcing layer 34 is shown exterior to the core layer 30. In some embodiments, the reinforcing layer 34 is at least partially embedded within the core layer 30. The reinforcing layer 34 provides strength to the flexible conduit 26 while still allowing it to be flexible and manipulable. The reinforcing layer 34 allows the flexible conduit 26 to withstand the relatively high pressures associated with the fire suppression system 20.

In one example, the reinforcing layer 34 comprises a mesh material. In the illustrated example the reinforcing layer 34 comprises two mesh layers 34A and 34B. In this example, the mesh layer 34B surrounds the mesh layer 34A.

In one example, the reinforcing layer 34 comprises a polyester fiber weave. Another example reinforcing layer 34 comprises aramid fibers.

A jacket layer 36 establishes an exterior surface 38 of the flexible conduit 26. The jacket layer 36 is schematically illustrated surrounding the reinforcing layer 34. In some examples, the reinforcing layer 34 will be at least partially embedded within the material of the jacket layer 36. Depending on the manufacturing process selected for making the flexible conduit 26, it is possible for some of the material of the jacket layer 36 to be blended with at least some of the material of the core layer 30 although distinct and separate layers are illustrated for discussion purposes.

The jacket layer 36 establishes the exterior surface 38. In one example, the jacket layer 36 comprises a flexible material that is different than the material of the core layer 30 and different than the material of the reinforcing layer 34. In another example, the jacket layer 36 comprises the same material as the core layer 30.

The exterior surface 38 is abrasion resistant and resistant to chemical reactions or corrosion that otherwise might occur as a result of contact between the exterior surface 38 and a substance within the building 22. The jacket layer 36 also is highly resistant to degradation of long term performance characteristics due to ultraviolet radiation.

In one example, the jacket layer 36 comprises an ether based thermoplastic polyurethane material. One example includes a fire retardant or intumescent component within the flexible material of the jacket layer 36. Several fire retardant components are known that are compatible with a thermoplastic polyurethane and those skilled in the art who have the benefit of this description will be able to select an appropriate composition of the jacket material to meet their particular needs.

The multiple layer construction of the flexible conduit 26 renders it useful for a fire suppression system. The core layer is compatible with the fire suppression fluid that will be retained within and carried through the flexible conduit 26. The reinforcing layer 34 provides strength to withstand the pressures that must be maintained for proper activation of a fire suppression system. The example reinforcing layer 34 provides strength by reducing stresses seen within the material of the core layer 30. The jacket layer 36 provides protection against damage, wear or breakdown of the flexible conduit 26.

The flexible conduit 26 facilitates faster and easier installation of a fire suppression system. It also reduces expenses associated with fittings and connections that are required for installing rigid pipe to carry fire suppression fluid from a source to a sprinkler. Eliminating fittings and connections also reduces the number of possible leak points in the system. The flexible conduit also does not present a risk of a compromised structure as a result of exposure to ultraviolet radiation or substances found within typical building structures.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A flexible conduit for use in a fire suppression system, comprising:
a core layer establishing an interior surface of the flexible conduit that is configured to contact fire suppression fluid;
a jacket layer surrounding the core layer, the jacket layer establishing an exterior surface of the flexible conduit; and
a reinforcing layer between the interior surface and the exterior surface, the reinforcing layer comprising a material that is different from a material of the core layer or the jacket layer.

2. The flexible conduit of claim 1, wherein the reinforcing layer comprises a mesh.

3. The flexible conduit of claim 2, wherein the reinforcing layer comprises a first mesh and a second mesh generally surrounding the first mesh.

4. The flexible conduit of claim 1, wherein the reinforcing layer comprises at least one of a polyester fiber weave or aramid fibers.

5. The flexible conduit of claim 1, wherein the reinforcing layer is at least partially embedded into at least one of the core layer or the jacket layer.

6. The flexible conduit of claim 1, wherein the jacket layer comprises an ether based thermoplastic polyurethane.

7. The flexible conduit of claim 1, wherein the jacket layer comprises a fire retardant component.

8. The flexible conduit of claim 1, wherein the core layer comprises at least one of polyethylene and nylon.

9. A fire suppression system, comprising:
at least one sprinkler; and
a flexible conduit between the sprinkler and a source of fire suppression fluid for carrying the fire suppression fluid to the sprinkler, the flexible conduit comprising
a core layer comprising a first flexible material, the core layer establishing an interior surface of the flexible conduit that is configured to contact the fire suppression fluid;
a jacket layer surrounding the core layer, the jacket layer comprising a second flexible material that is more abrasion resistant than the first flexible material, the jacket layer establishing an exterior surface of the flexible conduit; and
a reinforcing layer between the interior surface and the exterior surface, the reinforcing layer comprising a third material.

10. The fire suppression system of claim 9, wherein the reinforcing layer comprises a mesh.

11. The fire suppression system of claim 10, wherein the reinforcing layer comprises a first mesh and a second mesh generally surrounding the first mesh.

12. The fire suppression system of claim 9, wherein the reinforcing layer comprises at least one of a polyester fiber weave or aramid fibers.

13. The fire suppression system of claim 9, wherein the reinforcing layer is at least partially embedded into at least one of the core layer or the jacket layer.

14. The fire suppression system of claim 9, wherein the jacket layer comprises an ether based thermoplastic polyurethane.

15. The fire suppression system of claim 9, wherein the jacket layer comprises a fire retardant component.

16. The fire suppression system of claim 9, wherein the core layer comprises at least one of polyethylene and nylon.

17. A method of installing a fire suppression system, comprising:
providing at least one sprinkler; and
manipulating a flexible conduit into a position wherein the flexible conduit can carry fire suppression fluid to the sprinkler and the flexible conduit includes at least one bend or curve, the flexible conduit comprising
a core layer establishing an interior surface of the flexible conduit that is configured to contact the fire suppression fluid;
a jacket layer surrounding the core layer and establishing an exterior surface of the flexible conduit; and
a reinforcing layer between the interior surface and the exterior surface.

18. The method of claim 17, wherein the reinforcing layer comprises at least one of a polyester fiber weave or aramid fibers.

19. The method of claim 17, wherein the jacket layer comprises an ether based thermoplastic polyurethane.

20. The method of claim 17, wherein the core layer comprises at least one of polyethylene and nylon.
